(19) United States
(12) Patent Application Publication
(10) Pub. No.: US 2013/0092135 A1
(43) Pub. Date: Apr. 18, 2013

(54) METHOD FOR OPERATING AN INTERNAL COMBUSTION ENGINE

(71) Applicants: Guido Porten, Vaihingen/Enz (DE); Klaus Winkler, Rutesheim (DE); Thomas Zein, Sindelfingen (DE); Uwe Mueller, Cleebronn (DE)

(72) Inventors: Guido Porten, Vaihingen/Enz (DE); Klaus Winkler, Rutesheim (DE); Thomas Zein, Sindelfingen (DE); Uwe Mueller, Cleebronn (DE)

(21) Appl. No.: 13/642,411

(22) PCT Filed: Apr. 6, 2011
(86) PCT No.: PCT/EP11/55297

§ 371 Date: Jan. 2, 2013

(30) Foreign Application Priority Data
Apr. 20, 2010 (DE) 10 2010 027 970.6

(51) Int. Cl. F02M 25/07; F02B 47/08

(52) U.S. Cl. CPC F02M 25/0753; F02B 47/08
USPC 123/568.11

(57) ABSTRACT

In a method for operating an internal combustion engine, a measured NOₓ actual value is compared to an NOₓ setpoint value, and an exhaust gas recirculation is controlled as a function of a deviation of the NOₓ actual value from the NOₓ setpoint value. Respective portions of internally recirculated exhaust gases and externally recirculated exhaust gases of a total of recirculated exhaust gases are adjusted for controlling the exhaust gas recirculation.

### BACKGROUND OF THE INVENTION

1. FIELD OF THE INVENTION

The present invention relates to a method and a device for operating an internal combustion engine.

2. DESCRIPTION OF THE RELATED ART

Internal combustion engines, which may be spark ignition gasoline engines, are usually operated at an excess air factor or a lambda value of λ=1 to enable an optimal conversion of exhaust gas emissions in a catalytic converter designed as a three-way-catalytic converter, for example.

Moreover, low combustion temperatures are possible in a homogeneous combustion (HCCI), while avoiding a flame front. In this way, only few nitrogen oxide, or NOₓ, emissions or none at all develop. Thus, an engine operation at an excess air factor λ which is considerably greater than 1 is made possible without the use of an expensive NOₓ exhaust aftertreatment, e.g., NSC, in which the exhaust gas is guided via a nitrogen storage catalytic converter, or SCR (selective catalytic reduction). A dethrottling, in turn, results in an improved efficiency which leads to a lesser fuel consumption and to lower CO₂ emissions than in the case of a conventional spark ignition operation.

According to the present related art, in the HCCI operation, an exhaust gas recirculation takes place as a function of an operating point of the internal combustion engine, usually as a function of the rotational speed and the load, and/or as a function of combustion characteristics, which may typically be derived from the combustion chamber pressure and may describe the combustion phasing, for example, but not on the basis of measured NOₓ emissions in the exhaust gas.

### BRIEF SUMMARY OF THE INVENTION

Within the scope of the present invention, a quantity of nitrogen oxides (NOₓ) or a portion or a concentration of nitrogen oxides in the exhaust gas is controlled with the aid of exhaust gas recirculation during an HCCI operation. During the so-called HCCI operation (homogeneous charge compression ignition), the air/fuel mixture auto-ignites due to higher compression outlet temperatures, e.g., by retaining the hot exhaust gas in the cylinder when carrying out an internal and/or external exhaust gas recirculation.

For this purpose, a closed control loop is provided for adjusting an NOₓ-optimal inner (internal) and/or outer (external) exhaust gas recirculation during the HCCI operation and thus at the homogeneous compression ignition.

In one specific embodiment of the present invention, an adjustment of the exhaust gas recirculation (EGR), which results in a minimum untreated NOₓ emission, may be ascertained as a function of the operating point during the application phase in which the internal combustion engine is adjusted or set for an ongoing operation. The optimal NOₓ emission values ascertained in the process are stored as NOₓ setpoint values in an application characteristics field and may be adjusted over its service life in the vehicle by comparison to an NOₓ concentration measured during the operation and at least one NOₓ actual value derivable therefrom as well as by readjusting the EGR, typically during the operation. In this way, the external EGR may be readjusted with the aid of an EGR valve, for example. The internal EGR may be readjusted with the aid of a camshaft actuator.

This results in the effects of manufacturing tolerances of components of the internal combustion engine being reduced and also the long-term robustness of a system or a vehicle system having the internal combustion engine and, possibly, an exhaust gas system including at least one catalytic converter, being increased when compared to drifts or changing measuring factors, e.g., in the case of sooting of an exhaust gas recirculation valve.

The present invention allows when implemented for the optimal metering of the portions of the retained (internal) and the recirculated (external) exhaust gas during the HCCI operation due to the closed NOₓ control loop. In this way, an NOₓ-optimal operation of internal combustion engines is implementable for series-manufactured internal combustion engines even in the presence of component tolerances and long-term drifts.

It is provided within the scope of the present invention to install an NOₓ sensor, usually in a direction of an exhaust gas flow, upstream from the first catalytic converter of an exhaust gas system which is connected to the internal combustion engine. The NOₓ sensor is designed to measure the untreated NOₓ emissions and to ascertain and/or make available therefrom the instantaneous NOₓ actual values or a variable characterizing the untreated NOₓ emissions.

The NOₓ signal, which is made available based on an NOₓ concentration measured by sensors and includes the instantaneous NOₓ actual value, is used to adjust the untreated NOₓ emissions measured during the operation to a setpoint value. Starting from the NOₓ setpoint value, which is usually a function of the operating point, the operating parameters of the combustion are intervened with in the case of a system deviation. Thus, a targeted system intervention into the cooler, external EGR may influence the combustion temperature and thus the untreated NOₓ emissions, a portion of the exhaust gases of the internal, hotter exhaust gas recirculation being reduced. Other possible system interventions may influence the internal exhaust gas recirculation, if necessary, with the aid of a camshaft displacement or by adjusting the injection quantity.

At least one NOₓ setpoint value is ascertained during the application phase in that the exhaust gas recirculation for the internal combustion engine is adjusted in such a way that a minimum of nitrogen oxides results in the exhaust gases when other necessary boundary conditions, such as combustion stability, combustion phasing, noise and/or combustion chamber pressure, are taken into consideration. The at least one NOₓ setpoint value is subsequently stored as a function of suitable operating parameters, e.g., the rotational speed or the load, in a control unit for the vehicle system which includes the internal combustion engine and, if necessary, the exhaust gas system.

During a later operation of the internal combustion engine in the HCCI mode, this NOₓ setpoint value is then compared to the NOₓ actual value measured instantaneously by sensors, and a deviation from the NOₓ setpoint value possibly ascertained in the process is adjusted via a suitable controller, e.g., a PI controller or proportional integral controller, by adapting the exhaust gas recirculation. For this purpose, the portions of internally recirculated exhaust gases and of externally recirculated exhaust gases of the total of the recirculated exhaust gases are typically adjusted quantitatively and/or relatively to one another.

Since the exhaust gases emitted by the internal combustion engine require, depending on the exhaust gas mass flow and the sensor position, a different amount of time until they are detected and measured by the NOₓ sensor, and since the response behavior of the NOₓ sensor may additionally be a function of the mass flow, deviations between the NOₓ setpoint value and the NOₓ actual value measured by sensors which may inadvertently interfere with the controller, which adjusts the portions of internally and externally recirculated exhaust gases, usually result during dynamic operation.

For this reason, it may be provided during implementation to adapt the NOₓ setpoint value with the aid of a system model to the measuring position of the NOₓ sensor and to thus minimize the usually resulting deviations. The system model may be used to take into consideration spatially and/or over time the flow characteristics of the exhaust gases which exit the internal combustion engine and flow through the exhaust gas system.

This may take place similarly to a procedure for oxygen sensor emission control with the aid of a lambda sensor provided therefor. If the NOₓ sensor also provides a steady lambda signal, this signal may moreover be used to control the exhaust gas emissions of the gasoline engine during the HCCI operation at an excess air factor of λ=1 as well as during the homogeneous spark ignition operation of the internal combustion engine.

The nitrogen oxides (NOₓ) are thus controlled based on the actually emitted NOₓ concentrations on the basis of untreated NOₓ emissions. In order to keep the combustion temperature low even at increasing load, an increasing portion of exhaust gases is recirculated during implementation via the cooled external exhaust gas recirculation if the load increases.

The device according to the present invention is designed to carry out all steps of the presented method. Individual steps of this method may also be carried out by individual components of this device. Furthermore, functions of the device or functions of the individual components of the device may be implemented as steps of the method. In addition, it is possible to implement the steps of the method as functions of at least one component of the device or of the entire device.

Further advantages and embodiments of the present invention result from the description and the appended drawings.

It is understood that the above-named features and the features to be elucidated below are usable not only in the particular given combination, but also in other combinations or individually, without departing from the scope of the present invention.

### BRIEF DESCRIPTION OF THE DRAWINGS

FIG. 1 schematically shows a specific embodiment of a device according to the present invention.

FIG. 2 schematically shows one detail of a vehicle system which includes an internal combustion engine and an exhaust gas system having a catalytic converter.

### DETAILED DESCRIPTION OF THE INVENTION

The present invention is illustrated schematically in the drawings on the basis of one specific embodiment and is described in greater detail in the following with reference to the drawings.

The figures are described contextually and comprehensively; identical reference numerals identify identical components.

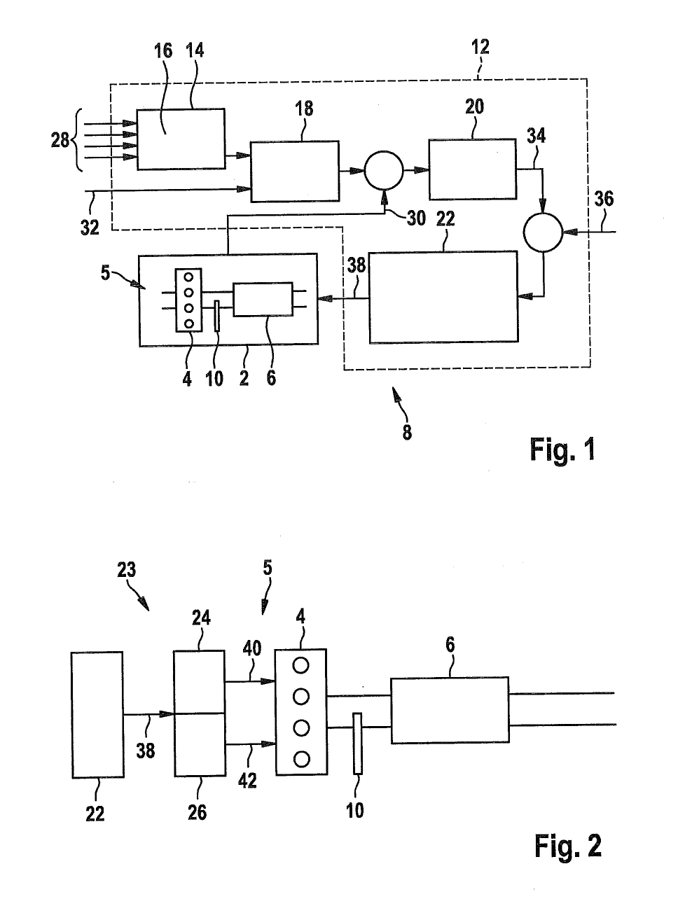

FIG. 1 schematically illustrates a vehicle system 2 having an internal combustion engine 5, which has a cylinder block 4, and a catalytic convert 6 as a component of an exhaust gas system.

Furthermore, FIG. 1 shows a specific embodiment of a device 8 according to the present invention, which in this case has a nitrogen oxide or NOₓ sensor 10, as well as a control unit 12 which is encircled by a dashed line in FIG. 1.

Control unit 12 of device 8 includes in the present specific embodiment a storage module 14 in which a number of NOₓ setpoint values 16 is stored within an application characteristics field. Furthermore, control unit 12 includes a system model 18, a proportional integral controller or PI controller 20, and an activation module 22.

Flow characteristics of the exhaust gases may be taken into consideration with the aid of system model 18; this applies, among other things, to a position of NOₓ sensor 10 in relation to internal combustion engine 4 and/or catalytic converter 6.

For further description of the present specific embodiment of the present invention, reference is made to FIG. 2 in which internal combustion engine 5, catalytic converter 6, and NOₓ sensor 10 from FIG. 1 are illustrated schematically once again.

As components of an exhaust gas recirculation system 23 of internal combustion engine 5, an external exhaust gas recirculation valve 24 for providing an external exhaust gas recirculation and an internal exhaust gas recirculation device 26 for providing an internal exhaust gas recirculation are illustrated in FIG. 2 for cylinder block 4 and thus for internal combustion engine 5. Moreover, FIG. 2 shows activation module 22 of control unit 12.

It is provided that NOₓ sensor 10 as a component of device 8 according to the present invention is situated upstream from first catalytic converter 6 of the exhaust gas system in the present specific embodiment. At the same time, this means that NOₓ sensor 10 is situated downstream from cylinder block 4 and thus downstream from internal combustion engine 5.

NOₓ setpoint values 16 are ascertained during a so-called application phase of internal combustion engine 5. The application of control unit 12 for internal combustion engine 5 and of the characteristics fields, the characteristics curves, and the control parameters, for example, stored therein, takes place during the development of internal combustion engine 5.

NOₓ setpoint values 16 depend, among other things, on operating parameters 28, such as a load, a rotational speed, or a temperature, of internal combustion engine 5. These NOₓ setpoint values 16 are adjusted as a function of operating parameters 28 in such a way that NOₓ setpoint values 16 correspond to a minimum NOₓ or nitrogen oxide portion and thus to a desirable, usually minimum NOₓ concentration 5 in the exhaust gases of internal combustion engine 5.

In one specific embodiment of the method according to the present invention, a nitrogen oxide portion or the NOₓ concentration of the exhaust gases of internal combustion engine 5 is measured during the operation with the aid of NOₓ sensor 10; an NOₓ actual value 30, which is a function of the operation, is ascertained based on that in each case, and is made available to control unit 12.

Furthermore, an instantaneous NOₓ setpoint value 16, which is a function of the operating point, and a value for an exhaust gas mass flow 32 prevailing during the operation are made available to system model 18 and are usually processed together. This usually includes the measure of adapting predefined NOₓ setpoint value 16 as a function of the flow to instantaneous exhaust gas mass flow 32 with the aid of system model 16 and, if necessary, modifying it.

Adapted or modified NOₓ setpoint value 16 and instantaneously ascertained NOₓ setpoint value 30 are supplied to PI controller 20. From the above-named, supplied values, a correction variable 34 for the exhaust gas recirculation is ascertained by PI controller 20 and transmitted together with at least one exhaust gas recirculation setpoint value 36 to activation module 22.

When implementing the method, NOₓ setpoint value 16 and measured NOₓ actual value 30 are compared, and correction variable 34 is controlled by PI controller 20 as a function of a deviation of NOₓ actual value 30 from NOₓ setpoint value 16.

It is also provided within the scope of the present invention that the at least one exhaust gas recirculation setpoint value 36 is ascertained together with NOₓ setpoint value 16 during the previously described application phase of internal combustion engine 5 in such a way that the exhaust gases of internal combustion engine 5 have a minimum NOₓ portion.

Activation module 22 transmits portion values 38 for external exhaust gas recirculation valve 24 and internal exhaust gas recirculation device 26 to exhaust gas recirculation system 23 on the basis of correction variable 34 as well as of the at least one exhaust gas recirculation setpoint value 36. These portion values 38 for the exhaust gas recirculation are used to adjust a composition of the portions, to be recirculated to cylinder block 4 and thus in total to internal combustion engine 5, of internal exhaust gases 42 and external exhaust gases 40 of an exhaust gas to be recirculated in total.

This means that in one embodiment, external exhaust gas recirculation valve 24 and internal exhaust gas recirculation device 26 are acted on via portion values 38 in'such a way that cylinder block 4 and thus internal combustion engine 5 are provided with the optimal portions of external exhaust gases 40 as well as internal exhaust gases 42.

The portion of inner or internal exhaust gases 42 is, for example, retained with the aid of a targeted valve undercut between the inlet valve and the outlet valve of a particular cylinder. For this purpose, an opening degree of the valves and the opening timing of the valves may be adapted with the aid of a camshaft actuator. The portion of external exhaust gases 40 is recirculated back to internal combustion engine 5 via external exhaust gas recirculation valve 24 from a section, usually a section of the exhaust gas system, downstream from internal combustion engine 5 in a direction of the exhaust gas flow.

Accordingly, external exhaust gases 40 may also be referred to as recirculated exhaust gases which are cooler than the hot internal exhaust gases 42 which are also referred to as the retained exhaust gases. With the aid of the specific embodiment of the present invention presented here, a closed NOₓ control loop is provided, among other things, for portions of external exhaust gases 40 and internal exhaust gases 42 of a total amount of exhaust gases.

1-10. (canceled)

11. A method for operating an internal combustion engine, comprising:
comparing a measured NOx actual value to an NOx setpoint value; and
controlling an exhaust gas recirculation as a function of a deviation of the NOx actual value from the NOx setpoint value, wherein respective portions of internally recirculated exhaust gases and externally recirculated exhaust gases of a total of recirculated exhaust gases are adjusted as a function of the deviation of the NOx actual value from the NOx setpoint value for controlling the exhaust gas recirculation.

12. The method as recited in claim 11, wherein:
values for an optimal NOx concentration are initially ascertained during an application phase as a function of operating parameters of the internal combustion engine; and
the NOx setpoint value is derived from the optimal NOx concentration and stored in an application characteristics field.

13. The method as recited in claim 12, wherein the NOx setpoint value is adjusted during the application phase in such a way that the NOx concentration in the exhaust gas is minimized.

14. The method as recited in claim 12, wherein the NOx setpoint value is adjusted over a service life of the internal combustion engine by comparison to a measured NOx concentration during a readjustment of the exhaust gas recirculation.

15. The method as recited in claim 11, wherein the method is executed for a gasoline internal combustion engine operating in a homogeneous compression ignition mode.

16. The method as recited in claim 11, wherein the NOx setpoint value is adjusted with the aid of a system model to a measuring position of an NOx sensor, and wherein the NOx sensor ascertains the NOx actual value.

17. The method as recited in claim 11, wherein the NOx setpoint value is adjusted by taking into consideration an instantaneous measured exhaust gas mass flow.

18. A control device for operating an internal combustion engine, comprising:
a measuring unit configured to measure an NOx actual value;
a comparator configured to compare the measured NOx actual value to an NOx setpoint value; and
a controller configured to control an exhaust gas recirculation as a function of a deviation of the NOx actual value from the NOx setpoint value, wherein respective portions of internally recirculated exhaust gases and externally recirculated exhaust gases of a total of recirculated exhaust gases are adjusted as a function of the deviation of the NOx actual value from the NOx setpoint value for controlling the exhaust gas recirculation.

19. The device as recited in claim 18, wherein the measuring unit is an NOx sensor which measures the NOx actual value and is situated upstream from a first catalytic converter of an exhaust gas system connected downstream from the internal combustion engine.

20. The device as recited in claim 18, wherein the controller is configured to implement a closed NOx control loop which controls respective portions of the internally recirculated exhaust gases and the externally recirculated exhaust gases.
